(19) United States
(12) Patent Application Publication
(10) Pub. No.: US 2025/0029771 A1
(43) Pub. Date: Jan. 23, 2025

(54) MULTILAYER INDUCTOR AND MULTILAYER INDUCTOR ARRAY

(71) Applicant: Murata Manufacturing Co., Ltd., Kyoto-fu (JP)

(72) Inventor: Yuichi OHBA, Nagaokakyo-shi (JP)

(73) Assignee: Murata Manufacturing Co., Ltd., Kyoto-fu (JP)

(21) Appl. No.: 18/774,219

(22) Filed: Jul. 16, 2024

(30) Foreign Application Priority Data
Jul. 21, 2023 (JP) 2023-118991

(51) Int. Cl. H01F 27/28; H01F 27/29

(52) U.S. Cl. CPC H01F 27/2804; H01F 27/29; H01F 2027/2809

(57) ABSTRACT

A multilayer inductor includes an element body including magnetic layers laminated in a lamination direction, a first, second, third and fourth external electrodes on a bottom surface of the element body, a first coil including a first winding portion formed by connecting, through vias, end portions of first conductors in different layers of the element body, a first through-conductor that connects one end of the first winding portion that is relatively close to the bottom surface and the first external electrode to each other, and a second through-conductor that connects the other end of the first winding portion that is relatively away from the bottom surface and the second external electrode to each other, and a second coil including a second winding portion.

### CROSS-REFERENCE TO RELATED APPLICATION

This application claims benefit of priority to Japanese Patent Application No. 2023-118991, filed Jul. 21, 2023, the entire content of which is incorporated herein by reference.

### BACKGROUND

### Technical Field

The present disclosure relates to a multilayer inductor and a multilayer inductor array.

### Background Art

In recent years, the high functionality of devices has increased the electric current and the efficiency of DC-to-DC converters in voltage conversion circuits, and similarly, the rated current of power inductors used in such devices has also increased.

Japanese Unexamined Patent Application Publication No. 2019-067883, which describes an example of such an inductor, discloses a coil component including a first coil conductor provided in a first insulating body and a second coil conductor provided in a second insulating body, wherein a first coil surface of the first coil conductor faces a second coil surface of the second coil conductor.

### SUMMARY

As described in Japanese Unexamined Patent Application Publication No. 2019-067883, when the coil component includes the first coil conductor and the second coil conductor, there is a difference in the DC resistance (R_{dc}) and/or the inductance value between the first coil conductor and the second coil conductor due to a difference in the shape and/or a difference in the wiring length between a lead-out conductor of the first coil conductor (see FIG. 2 of Japanese Unexamined Patent Application Publication No. 2019-067883) and a lead-out conductor of the second coil conductor (see FIG. 3 of Japanese Unexamined Patent Application Publication No. 2019-067883).

In view of the problems described above, the embodiments according to the present disclosure reduce the difference in the DC resistance and/or the inductance value between a plurality of coil conductors included in an inductor.

A multilayer inductor according to the present disclosure includes an element body including a plurality of magnetic layers laminated in a lamination direction; and a first external electrode, a second external electrode, a third external electrode, and a fourth external electrode that are provided on a bottom surface of the element body. The multilayer inductor also includes a first coil including a first winding portion formed by connecting, through a via, end portions of a plurality of first conductors disposed in different layers of the element body, a first through-conductor that connects one end of the first winding portion that is relatively close to the bottom surface and the first external electrode to each other, and a second through-conductor that connects another end of the first winding portion that is relatively away from the bottom surface and the second external electrode to each other. The multilayer inductor further includes a second coil including a second winding portion formed by connecting, through a via, end portions of a plurality of second conductors disposed in different layers of the element body, a third through-conductor that connects one end of the second winding portion that is relatively close to the bottom surface and the third external electrode to each other, and a fourth through-conductor that connects another end of the second winding portion that is relatively away from the bottom surface and the fourth external electrode to each other. A first conductor and a second conductor are provided in a single layer. The first conductor is one of the plurality of first conductors, the second conductor is one of the plurality of second conductors, and an area of the first conductor in plan view is substantially identical to an area of the second conductor in plan view in the single layer, and the first conductors and the second conductors are alternately disposed as viewed in a direction intersecting the lamination direction.

Alternatively, a multilayer inductor comprises an element body including a plurality of magnetic layers laminated in a lamination direction; a first external electrode, a second external electrode, a third external electrode, a fourth external electrode, a fifth external electrode, a sixth external electrode, a seventh external electrode, and an eighth external electrode that are provided on a bottom surface of the element body. The multilayer inductor also includes a first coil including a first winding portion formed by connecting, through a via, end portions of a plurality of first conductors disposed in different layers of the element body, a first through-conductor that connects one end of the first winding portion that is relatively close to the bottom surface and the first external electrode to each other, and a second through-conductor that connects another end of the first winding portion that is relatively away from the bottom surface and the second external electrode to each other. The multilayer inductor further includes a second coil including a second winding portion formed by connecting, through a via, end portions of a plurality of second conductors disposed in different layers of the element body, a third through-conductor that connects one end of the second winding portion that is relatively close to the bottom surface and the third external electrode to each other, and a fourth through-conductor that connects another end of the second winding portion that is relatively away from the bottom surface and the fourth external electrode to each other. The multilayer inductor also includes a third coil including a third winding portion formed by connecting, through a via, end portions of a plurality of third conductors disposed in different layers of the element body, a fifth through-conductor that connects one end of the third winding portion that is relatively close to the bottom surface and the fifth external electrode to each other, and a sixth through-conductor that connects another end of the third winding portion that is relatively away from the bottom surface and the sixth external electrode to each other, a fourth coil including a fourth winding portion formed by connecting, through a via, end portions of a plurality of fourth conductors disposed in different layers of the element body, a seventh through-conductor that connects one end of the fourth winding portion that is relatively close to the bottom surface and the seventh external electrode to each other, and an eighth through-conductor that connects another end of the fourth winding portion that is relatively away from the bottom surface and the eight external electrode to each other. The third coil and the fourth coil are adjacent to each other in a direction intersecting the lamination direction with respect to the first coil and the second coil. A first conductor and a second conductor are provided in a single (same) layer. The first conductor is one of the plurality of first conductors, and the second conductor is one of the plurality of second conductors. An area of the first conductor in plan view is substantially identical to an area of the second conductor in plan view in the single (same) layer. The first conductors and the second conductors are alternately disposed in the direction intersecting the lamination direction. The third conductor and the fourth conductor are provided in a single layer. The third conductor is one of the plurality of third conductors, the fourth conductor is one of the plurality of fourth conductors, an area of the third conductor in plan view is substantially identical to an area of the fourth conductor in plan view in the single layer, and the third conductors and the fourth conductors are alternately disposed in the direction intersecting the lamination direction.

According to the present disclosure, in an inductor having a plurality of coils therein, the difference in the DC resistance and/or the inductance value between the coils can be reduced. Specifically, since the first conductor and the second conductor are provided in a single layer. The area of the first conductor in plan view is substantially identical to the area of the second conductor in plan view in the single layer, the first conductors and the second conductors are alternately disposed in the direction intersecting the lamination direction, and the shapes of the coils are similar and the wiring length and the like can be made identical. Accordingly, the difference in the DC resistance and/or the inductance value between the coils can be reduced.

### BRIEF DESCRIPTION OF THE DRAWINGS

FIG. 1 is a perspective view schematically illustrating an example of a multilayer inductor according to the present disclosure;

FIG. 2 is a perspective view schematically illustrating an example of a first coil and a second coil according to the present disclosure;

FIG. 3 is an exploded perspective view schematically illustrating an example of an internal structure of the multilayer inductor according to the present disclosure;

FIG. 4 is a cross-sectional view schematically illustrating an example of the multilayer inductor according to the present disclosure;

FIG. 5 is a cross-sectional view schematically illustrating an example of another multilayer inductor according to the present disclosure; and

FIG. 6 is a perspective view schematically illustrating an example of a multilayer inductor array according to the present disclosure.

### DETAILED DESCRIPTION

A multilayer inductor according to the present disclosure will be described below. It should be noted that the present disclosure is not limited to the following structure and may be changed as appropriate without departing from the spirit of the present disclosure. A combination of preferred structures described below is also the present disclosure.

The multilayer inductor according to the present disclosure is used for, for example, DC-to-DC converters. The multilayer inductor according to the present disclosure can also be used for devices other than DC-to-DC converters.

In this specification, terms indicating the relationship between elements (for example, “parallel” and “orthogonal”) and terms indicating the shape of elements represent not only strict literal aspects but also a substantially equivalent range, for example, a range including a difference of several percent. It should be noted that, in this specification, the direction in which magnetic layers and coil conductors that constitute an element body are laminated is referred to as “lamination direction”.

The drawings below are schematic, and the dimensions, the aspect ratios, and the like in the drawings may differ from those of actual products.

### Multilayer Inductor

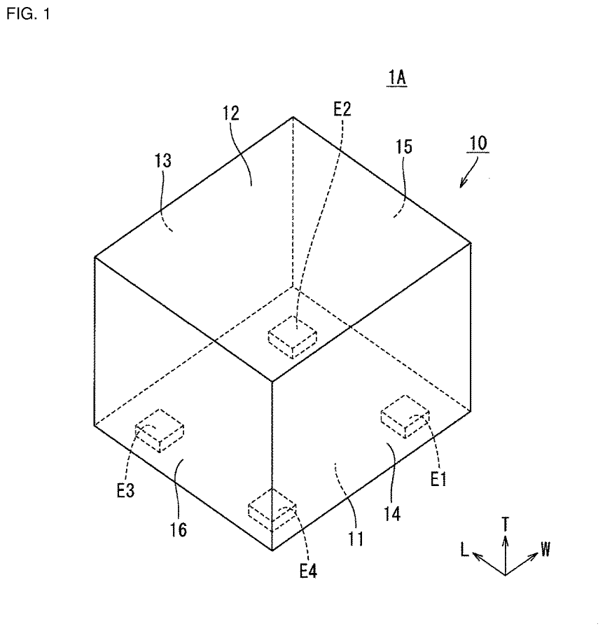

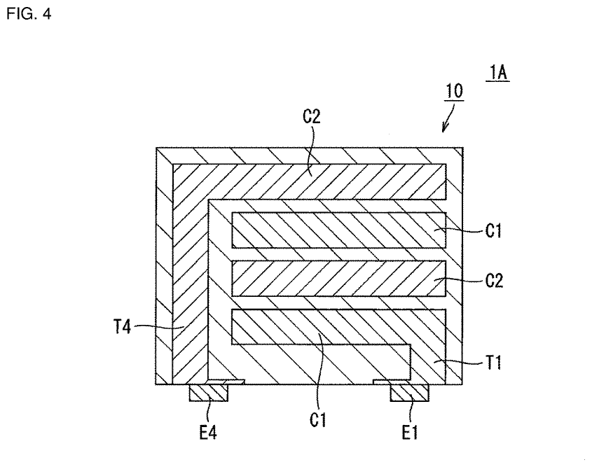

First, a multilayer inductor according to an embodiment of the present disclosure will be described with reference to FIGS. 1 to 4. It should be noted that the shapes, the disposition, and the like of the multilayer inductor and individual components thereof are not limited to the example in the drawings.

A multilayer inductor 1A illustrated in FIG. 1 includes an element body 10, a first external electrode E1, a second external electrode E2, a third external electrode E3, and a fourth external electrode E4 that are provided on the bottom surface of the element body 10, and a first coil 21 and a second coil 22. The individual components will be described in detail below.

### Element Body

The element body 10 has, for example, a rectangular parallelepiped shape or a substantially rectangular parallelepiped shape and six surfaces. The corner portions and the ridge portions of the element body 10 may be rounded. Three surfaces of the element body 10 intersect at each of the corner portions, and two surfaces of the element body 10 intersect at each of the ridge portions.

In FIG. 1, a length direction, a width direction, and a height direction of the multilayer inductor 1A and the element body 10 are represented by L, W, and T, respectively. A length direction L, a width direction W, and a height direction T are orthogonal to each other. A mounting surface of the multilayer inductor 1A is, for example, an LW plane parallel to the length direction L and the width direction W.

The element body 10 illustrated in FIG. 1 has a first main surface 11 and a second main surface 12 that face away from each other in the height direction T, a first end surface 13 and a second end surface 14 that face away from each other in the length direction L, and a first side surface 15 and a second side surface 16 that face away from each other in the width direction W. In the example illustrated in FIG. 1, the first external electrode E1, the second external electrode E2, the third external electrode E3, and the fourth external electrode E4 are formed on the first main surface 11 of the element body 10, and the first main surface 11 corresponds to the mounting surface (bottom surface) of the element body 10.

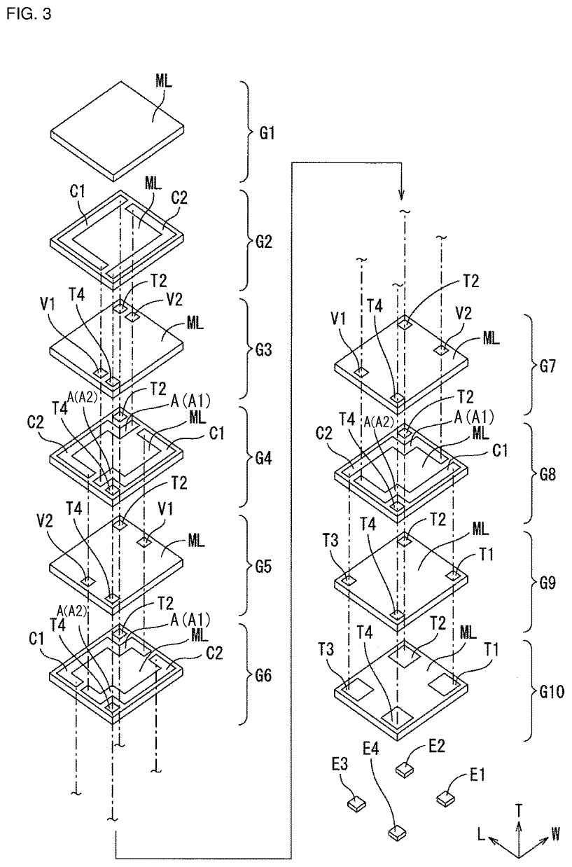

The element body 10 includes a plurality of magnetic layers ML laminated in the lamination direction. In addition, the first coil 21 including a first conductor C1 described later and the second coil 22 including a second conductor C2 described later may be provided in the element body 10. In the embodiment, as illustrated in FIG. 3, the element body 10 includes multilayer groups G1 to G10 laminated together and external electrodes E1 to E4 formed below the multilayer group G10. It should be noted that the boundaries between these layers constituting the multilayer structure of the element body 10 need not be visible. In addition, the multilayer groups G1 to G10 may be formed by laminating a plurality of layers with an identical pattern.

The multilayer group G1 has the magnetic layer ML and may constitute the second main surface 12 of the element body 10.

The multilayer group G2 includes the magnetic layer ML and a first conductor C1 and a second conductor C2 that are disposed in a single layer. In addition, the area of the first conductor C1 in plan view in the lamination direction in the single layer is substantially identical to the area of the second conductor C2 in plan view in the lamination direction. Here, “substantially identical” may include the range of ±10%, more preferably the range of ±5%. It should be noted that the area of the first conductor C1 and the area of the second conductor C2 can be calculated by, for example, polishing an inductor sample in a direction parallel to the LW plane, taking a photograph of an obtained surface of the multilayer group by using a digital microscope, and calculating the areas from the taken photograph by using an image analysis function.

The first conductor C1 of the multilayer group G2 may be disposed along two sides that form a corner portion (for example, a corner portion close to the third external electrode E3 in planar transparent view) of the magnetic layer ML. That is, the first conductor C1 may be formed in an L-shape in plan view in the lamination direction. A second through-conductor (not illustrated) connected to the second external electrode E2 may be provided in one end portion (for example, an end portion close to the second external electrode E2 in planar transparent view) of the first conductor C1. In addition, a via (not illustrated) connected to a first via V1 of the multilayer group G3 may be provided in the other end portion (for example, an end portion close to the fourth external electrode E4 in planar transparent view) of the first conductor C1. It should be noted that “end portion” includes not only an end but also a portion in the vicinity of an end.

The second conductor C2 of the multilayer group G2 may be disposed along two sides that form another corner portion (for example, a corner portion close to the first external electrode E1 in planar transparent view) of the magnetic layer ML. That is, the second conductor C2 may be formed in an L-shape in plan view in the lamination direction. A via (not illustrated) connected to a second via V2 of the multilayer group G3 may be provided in one end portion of the second conductor C2 (for example, an end portion close to the second external electrode E2 in planar transparent view). In addition, a fourth through-conductor (not illustrated) connected to the fourth external electrode E4 may be provided in the other end portion of the second conductor C2 (for example, an end portion close to the fourth external electrode E4 in planar transparent view).

The multilayer group G3 may include the magnetic layer ML, the first via V1 that connects the first conductors C1 adjacent to each other in the lamination direction, the second via V2 that connects the second conductors C2 adjacent to each other in the lamination direction, a second through-conductor T2, and a fourth through-conductor T4.

The first via V1 of the multilayer group G3 may be disposed at a position at which the first via V1 is connected to the other end portion (the end portion close to the fourth external electrode E4 in planar transparent view) of the first conductor C1 of the multilayer group G2 described above. The first via V1 of the multilayer group G3 may be disposed adjacent to the fourth through-conductor T4 in plan view in the lamination direction, at a distance that ensures electrical insulation from the fourth through-conductor T4.

The second via V2 of the multilayer group G3 may be disposed at a position at which the second via V2 is connected to one end portion (the end portion close to the second external electrode E2 in planar transparent view) of the second conductor C2 of the multilayer group G2 described above. The second via V2 of the multilayer group G3 may be disposed adjacent to the second through-conductor T2 in plan view in the lamination direction, at a distance that ensures electrical insulation from the second through-conductor T2.

The second through-conductor T2 of the multilayer group G3 may be electrically connected to the second external electrode E2 by connecting the second through-conductors T2 of the multilayer groups G2 and G4 that are adjacent to each other in the lamination direction. Accordingly, the second through-conductors T2 may be disposed above the second external electrode E2 in planar transparent view.

The fourth through-conductor T4 of the multilayer group G3 may be electrically connected to the fourth external electrode E4 by connecting the fourth through-conductors T4 of the multilayer groups G2 and G4 that are adjacent to each other in the lamination direction. Accordingly, the fourth through-conductors T4 may be disposed above the fourth external electrode E4 in planar transparent view.

The multilayer group G4 may include the magnetic layer ML, the first conductor C1 and the second conductor C2 that are disposed in a single layer, the second through-conductor T2, and the fourth through-conductor T4. In addition, the area of the first conductor C1 in the lamination direction in the single layer is substantially identical to the area of the second conductor C2 in plan view in the lamination direction. Here, “substantially identical” may include the range of ±10%, more preferably the range of ±5%.

The first conductor C1 of the multilayer group G4 may be connected to the first conductor C1 of the multilayer group G2 via the first via V1 of the multilayer group G3 to form a portion of the winding of the first coil 21. Specifically, the first conductor C1 of the multilayer group G4 is disposed along at least one side of the magnetic layer ML located on the opposite side of a side of the magnetic layer ML disposed along the first conductor C1 of the multilayer group G2 in plan view in the lamination direction, and the first conductor C1 of the multilayer group G4 may have an avoidance portion A that avoids the fourth through-conductor T4. A specific aspect of the avoidance portion A will be described later. A via (not illustrated) connected to the first via V1 of the multilayer group G5 may be provided in one end portion of the first conductor C1 (an end portion close to the second external electrode E2 in planar transparent view). In addition, the other end portion of the first conductor C1 (an end portion close to the fourth external electrode E4 in planar transparent view) may be connected to the first via V1 of the multilayer group G3.

The second conductor C2 of the multilayer group G4 may be connected to the second conductor C2 of the multilayer group G2 via the second via V2 of the multilayer group G3 to form a portion of the winding of the second coil 22. Specifically, the second conductor C2 of the multilayer group G4 is disposed along at least one side of the magnetic layer ML located on the opposite side of a side of the magnetic layer ML disposed along the second conductor C2 of the multilayer group G2 in plan view in the lamination direction, and the second conductor C2 of the multilayer group G4 may have the avoidance portion A that avoids the second through-conductor T2. One end portion of the second conductor C2 (an end portion close to the second external electrode E2 in planar transparent view) may be connected to the second via V2 of the multilayer group G3. In addition, in the other end portion of the second conductor C2 (an end portion close to the second external electrode E2 in planar transparent view), a via (not illustrated) connected to the second via V2 of the multilayer group G5 may be provided.

The second through-conductor T2 of the multilayer group G4 may be electrically connected to the second external electrode E2 by connecting the second through-conductors T2 of the multilayer groups G3 and G5 that are adjacent to each other in the lamination direction. Accordingly, the second through-conductors T2 may be disposed in the corner portion of the magnetic layer ML located above the second external electrode E2.

The fourth through-conductor T4 of the multilayer group G4 may be electrically connected to the fourth external electrode E4 by connecting the fourth through-conductors T4 of the multilayer groups G3 and G5 that are adjacent to each other in the lamination direction. Accordingly, the fourth through-conductors T4 may be disposed in the corner portion of the magnetic layer ML located above the fourth external electrode E4.

The multilayer group G5 may include the magnetic layer ML, the first via V1 that connects the first conductors C1 adjacent to each other in the lamination direction, the second via V2 that connects the second conductors C2 adjacent to each other in the lamination direction, the second through-conductor T2, and the fourth through-conductor T4.

The first via V1 of the multilayer group G5 may be disposed at a position at which the first via V1 is connected to one end portion of the first conductor C1 of the multilayer group G4 described above. The first via V1 of the multilayer group G5 may be provided in a portion close to a side of the magnetic layer ML on the opposite side of the first via V1 of the multilayer group G3 in planar transparent view.

The second via V2 of the multilayer group G5 may be disposed at a position at which the second via V2 is connected to one end portion of the second conductor C2 of the multilayer group G4 described above. The second via V2 of the multilayer group G5 may be provided in a portion close to a side of the magnetic layer ML on the opposite side of the second via V2 of the multilayer group G3 in planar transparent view.

The second through-conductor T2 of the multilayer group G5 may be electrically connected to the second external electrode E2 by connecting the second through-conductors T2 of the multilayer groups G4 and G6 that are adjacent to each other in the lamination direction. Accordingly, the second through-conductors T2 may be disposed in the corner portion of the magnetic layer ML located above the second external electrode E2 in planar transparent view.

The fourth through-conductor T4 of the multilayer group G5 may be electrically connected to the fourth external electrode E4 by connecting the fourth through-conductors T4 of the multilayer groups G4 and G6 that are adjacent to each other in the lamination direction. Accordingly, the fourth through-conductors T4 may be disposed in the corner portion of the magnetic layer ML located above the fourth external electrode E4 in planar transparent view.

The multilayer group G6 may include the magnetic layer ML, the first conductor C1 and the second conductor C2 that are disposed in a single layer, the second through-conductor T2, and the fourth through-conductor T4. In addition, the area of the first conductor C1 in the lamination direction in the single layer is substantially identical to the area of the second conductor C2 in plan view in the lamination direction. Here, “substantially identical” may include the range of ±10%, more preferably the range of ±5%.

The first conductor C1 of the multilayer group G6 may be connected to the first conductor C1 of the multilayer group G4 via the first via V1 of the multilayer group G5 to form a portion of the winding of the first coil 21. Specifically, the first conductor C1 of the multilayer group G6 is disposed along at least one side of the magnetic layer ML located on the opposite side of a side of the magnetic layer ML disposed along the first conductor C1 of the multilayer group G4 in plan view in the lamination direction, and the first conductor C1 of the multilayer group G6 may have the avoidance portion A that avoids the second through-conductor T2. One end portion of the first conductor C1 may be connected to the first via V1 of the multilayer group G5. In addition, in the other end portion of the first conductor C1, a via (not illustrated) connected to the first via V1 of the multilayer group G7 may be provided.

The second conductor C2 of the multilayer group G6 may be connected to the second conductor C2 of the multilayer group G4 via the second via V2 of the multilayer group G5 to form a portion of the winding of the second coil 22. Specifically, the second conductor C2 of the multilayer group G6 is disposed along at least one side of the magnetic layer ML located on the opposite side of a side of the magnetic layer ML disposed along the second conductor C2 of the multilayer group G4 in plan view in the lamination direction, and the second conductor C2 of the multilayer group G6 may have the avoidance portion A that avoids the fourth through-conductor T4. In one end portion of the second conductor C2, a via (not illustrated) connected to the second via V2 of the multilayer group G7 may be provided. In addition, the other end portion of the second conductor C2 may be connected to the second via V2 of the multilayer group G5.

The second through-conductor T2 of the multilayer group G6 may be electrically connected to the second external electrode E2 by connecting the second through-conductors T2 of the multilayer groups G5 and G7 that are adjacent to each other in the lamination direction. Accordingly, the second through-conductors T2 may be disposed in the corner portion of the magnetic layer ML located above the second external electrode E2.

The fourth through-conductor T4 of the multilayer group G6 may be electrically connected to the fourth external electrode E4 by connecting the fourth through-conductors T4 of the multilayer groups G5 and G7 that are adjacent to each other in the lamination direction. Accordingly, the fourth through-conductors T4 may be disposed in the corner portion of the magnetic layer ML located above the fourth external electrode E4.

The multilayer group G7 may include the magnetic layer ML, the first via VI that connects the first conductors C1 to each other, the second via V2 that connects the second conductors C2 to each other, the second through-conductor T2, and the fourth through-conductor T4.

The first via V1 of the multilayer group G7 may be disposed at a position at which the first via V1 is connected to the other end portion (an end portion close to the third external electrode E3 in planar transparent view) of the first conductor C1 of the multilayer group G6 described above. The first via V1 of the multilayer group G7 may be disposed adjacent to the fourth through-conductor T4 in plan view in the lamination direction, at a distance that ensures electrical insulation from the fourth through-conductor T4. The first via V1 of the multilayer group G7 may be provided in a portion close to a side of the magnetic layer ML on the opposite side of the first via V1 of the multilayer group G5 in planar transparent view.

The second via V2 of the multilayer group G7 may be disposed at a position at which the second via V2 is connected to one end portion (an end portion close to the first external electrode E1 in the planar transparent view) of the second conductor C2 of the multilayer group G4 described above. The second via V2 of the multilayer group G7 may be disposed adjacent to the second through-conductor T2 in plan view in the lamination direction, at a distance that ensures electrical insulation from the second through-conductor T2. The second via V2 of the multilayer group G7 may be provided in a portion close to a side of the magnetic layer ML on the opposite side of the second via V2 of the multilayer group G5 in planar transparent view.

The second through-conductor T2 of the multilayer group G7 may be electrically connected to the second external electrode E2 by connecting the second through-conductors T2 of the multilayer groups G6 and G8 that are adjacent to each other in the lamination direction. Accordingly, the second through-conductors T2 may be disposed in the corner portion of the magnetic layer ML located above the second external electrode E2 in planar transparent view.

The fourth through-conductor T4 of the multilayer group G7 may be electrically connected to the fourth external electrode E4 by connecting the fourth through-conductors T4 of the multilayer groups G6 and G8 that are adjacent to each other in the lamination direction. Accordingly, the fourth through-conductors T4 may be disposed in the corner portion of the magnetic layer ML located above the fourth external electrode E4 in planar transparent view.

The multilayer group G8 may include the magnetic layer ML, the first conductor C1 and the second conductor C2 that are disposed in a single layer, the second through-conductor T2, and the fourth through-conductor T4. In addition, the area of the first conductor C1 in the lamination direction in the single layer is substantially identical to the area of the second conductor C2 in plan view in the lamination direction. Here, “substantially identical” may include the range of ±10%, more preferably the range of ±5%.

The first conductor C1 of the multilayer group G8 may be connected to the first conductor C1 of the multilayer group G6 via the first via VI of the multilayer group G7 to form a portion of the winding of the first coil 21. Specifically, the first conductor C1 of the multilayer group G8 is disposed along at least one side of the magnetic layer ML located on the opposite side of a side of the magnetic layer ML disposed along the first conductor C1 of the multilayer group G6 in plan view in the lamination direction, and the first conductor C1 of the multilayer group G8 may have the avoidance portion A that avoids the fourth through-conductor T4. A first through-conductor (not illustrated) connected to the first external electrode E1 may be provided in one end portion of the first conductor C1 (an end portion close to the first external electrode E1 in planar transparent view). In addition, the other end portion of the first conductor C1 (an end portion close to the third external electrode E3 in planar transparent view) may be connected to the first via V1 of the multilayer group G7.

The second conductor C2 of the multilayer group G8 may be connected to the second conductor C2 of the multilayer group G6 via the second via V2 of the multilayer group G7 to form a portion of the winding of the second coil 22. Specifically, the second conductor C2 of the multilayer group G8 is disposed along at least one side of the magnetic layer ML located on the opposite side of a side of the magnetic layer ML disposed along the second conductor C2 of the multilayer group G6 in plan view in the lamination direction, and the second conductor C2 of the multilayer group G8 may have the avoidance portion A that avoids the second through-conductor T2. One end portion of the second conductor C2 (an end portion close to the first external electrode E1 in planar transparent view) may be connected to the second via V2 of the multilayer group G7. In addition, the third through-conductor (not illustrated) connected to the third external electrode E3 may be provided in the other end portion of the first conductor C1 (an end portion close to the third external electrode E3 in planar transparent view).

The multilayer group G9 may include the magnetic layer ML, the first through-conductor T1, the second through-conductor T2, the third through-conductor, and the fourth through-conductor T4. The areas of the first to fourth through-conductors T1 to T4 of the multilayer groups G1 to G9 in plan view in the lamination direction may be substantially identical to each other.

The multilayer group G10 may include the magnetic layer ML, the first through-conductor T1, the second through-conductor T2, the third through-conductor, and the fourth through-conductor T4. In the multilayer group G10, the areas of the first to fourth through-conductors T1 to T4 of the multilayer group G10 in plan view in the lamination direction may be greater than the areas of the first to fourth through-conductors T1 to T4 of the multilayer groups G1 to G9, and the thickness of the multilayer group G10 may be greater than the thicknesses of the multilayer group 9. When the plane areas of the first to fourth through-conductors T1 to T4 of the multilayer group G10 are greater than the areas of the first external electrode E1 to the fourth external electrode E4, even if heat shrinkage caused by burning occurs, positioning with respect to the first external electrode E1 to the fourth external electrode E4 can be easily performed.

Here, the thicknesses of the first conductor C1 and/or the second conductor C2 of the individual multilayer groups may be identical to each other. An example of the material of the first conductor C1 and/or the second conductor C2 may be a metal conductor, such as Ag and/or Cu. The first conductor Cl and/or the second conductor C2 may be formed by, for example, printing a conductive paste on the magnetic layer ML described above.

In addition, an example of the material of the first to fourth through-conductors T4, the first via V1, and the second via V2 may be a metal conductor, such as Ag and/or Cu. In addition, the material of the first to fourth through-conductors T4, the first via V1, and the second via V2 may be similar to or different from the material of the first conductor C1 and/or the second conductor C2. The through-conductors and the via conductors may be formed by, for example, forming through-bores in the magnetic layer ML described above and printing a conductive paste on the inside of the through-bores or printing a conductive paste and then printing the magnetic layer ML outside the conductive paste.

When the element body 10 has a multilayer structure including the multilayer groups G1 to G10 as described above, the design flexibility of the multilayer inductor 1A increases. For example, when the multilayer inductor 1A including the first external electrode E1, the second external electrode E2, the third external electrode E3, and the fourth external electrode E4 is manufactured on the bottom surface (first main surface 11) of the element body 10, the first coil 21 and the second coil 22 can be easily drawn toward the bottom surface. It should be noted that, the multilayer structure including the multilayer groups G1 to G10 may be formed by sequentially printing (for example, screen-printing), from the second main surface 12 side or the first main surface 11 side of the element body 10, a material constituting the magnetic layer ML, a material constituting the first conductor C1 or the second conductor C2, and a material constituting the through-conductors and/or the vias in a laminated manner. In this case, in each of the multilayer groups G1 to G10, printing may be performed repeatedly until the magnetic layer ML, the first conductor C1 and/or the second conductor C2, and the through-conductors and/or the vias each have a desired thickness.

In addition, in the multilayer groups G1 to G10, the area of the first conductor C1 in the lamination direction is substantially identical to the area of the second conductor C2 in plan view in the lamination direction in a single layer, which is one feature of the multilayer inductor 1A according to the present disclosure. Here, “substantially identical” may include the range of ±10%, more preferably the range of ±5%. Accordingly, it is possible to reduce the difference between the wiring resistance and the inductance value that depend on the area of the first conductor C1 in plan view in the lamination direction and the wiring resistance and the inductance value that depend on the area of the second conductor C2 in plan view in the lamination direction.

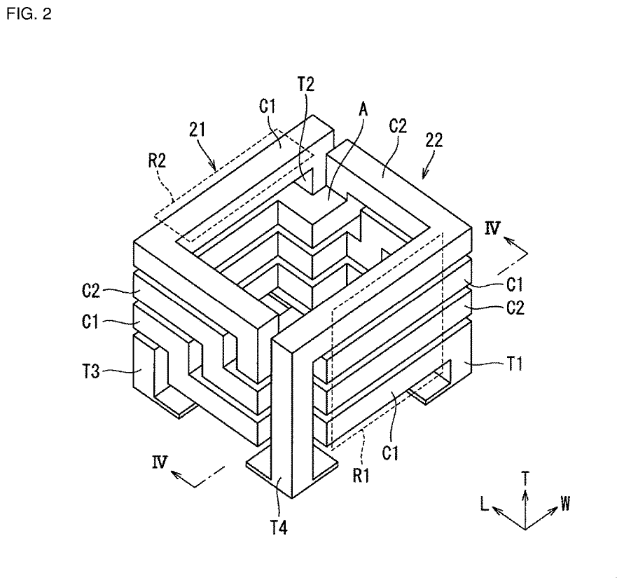

In addition, the first conductors C1 and the second conductors C2 are alternately disposed as viewed in a direction intersecting the lamination direction, which is one feature of the multilayer inductor 1A according to the present disclosure. More specifically, in FIGS. 2 and 3, in transparent view of the element body 10 in the length direction L (or in the width direction W), there is a region R1 in which the first conductors C1 and the second conductors C2 are alternately disposed (see FIG. 2). As described above, with the first conductor C1 and the second conductor C2 provided in a single layer, the area of the first conductor C1 is substantially identical to the area of the second conductor C2 in plan view in the lamination direction, and the first conductors C1 and the second conductors C2 are alternately disposed in the direction intersecting the lamination direction. Accordingly, reduction in the difference in the wiring resistance and the inductance value can be determined in accordance with the shapes and the disposition of the first conductors C1 and the second conductors C2 regardless of whether the first conductors C1 and the second conductors C2 are viewed in the lamination direction (in plan view in the lamination direction) or in the direction intersecting the lamination direction.

Additional elements regarding the element body 10 will be described. The magnetic layer ML may contain metal magnetic particles that are made of a magnetic material. The metal magnetic particles may contain Fe and/or Si. More specifically, the metal magnetic particles may be Fe particles or Fe alloy particles. The Fe alloy may be Fe—Si alloy, Fe—Si—Cr alloy, Fe—Si—Al alloy, Fe—Si—B—P—Cu—C alloy, Fe—Si—B—Nb—Cu alloy, or the like. In addition, the metal magnetic particles may contain impurities, such as Cr, Mn, Cu, Ni, P, S, and Co, that are not intended during manufacturing. In addition, the metal magnetic particles may also be contained in a magnetic paste. Accordingly, the metal magnetic particles may contain elements (for example, Cr, Al, Li, and Zn) that are more easily oxidized than Fe to be added when the magnetic paste is created.

The surface of the metal magnetic particles described above may be covered with an insulating coating, which is not illustrated. When the surface of the metal magnetic particles is covered with an insulating coating, the insulation between the metal magnetic particles can be improved. The insulating coating on the surface of the metal magnetic particles can be formed by a sol-gel method, a mechanochemical method, or the like. The material of the insulating coating may be P-or Si-oxides, zinc phosphate, or manganese phosphate. Alternatively, the insulating coating may be an oxide film formed by oxidation of the surface of the metal magnetic particles. The thickness of the insulating coating is preferably 1 nm or more and 50 nm or less (i.e., from 1 nm to 50 nm), more preferably 1 nm or more and 30 nm or less (i.e., from 1 nm to 30 nm), even more preferably 1 nm or more and 20 nm or less (i.e., from 1 nm to 20 nm). For example, a photograph of a cross-section obtained by polishing an inductor sample is taken by using a scanning electron microscope (SEM), and the thickness of the insulating coating covering the surface of the metal magnetic particle can be measured from the obtained SEM photograph.

The average particle diameter of the metal magnetic particles in the magnetic layer ML is preferably 1 μm or more and 30 μm or less (i.e., from 1 μm to 30 μm), more preferably 1 μm or more and 20 μm or less (i.e., from 1 μm to 20 μm), even more preferably 1 μm or more and 10 μm or less (i.e., from 1 μm to 10 μm). The average particle diameter of the metal magnetic particles in the magnetic layer can be measured by the procedure described below. The inductor sample is cut to obtain a cross-section of the sample. Specifically, a cross section of the sample is obtained by cutting the sample along a plane that includes the center of the element body and is orthogonal to the mounting surface and the end surface of the element body. Photographs of plurality of regions (for example, five regions having a size of, for example, 130 μm×100 μm) of the obtained cross-section are taken by a SEM, the obtained SEM images are analyzed by image analysis software (for example, image analysis software WinROOF2021 created by Mitani Corporation), and the equivalent circle diameters of the metal magnetic particles are obtained. The average value of the obtained equivalent circle diameters is defined as the average particle diameter of the metal magnetic particles.

When the element body 10 is formed by heat treatment. In this case, the metal magnetic particles included in the element body 10 have oxide films on the surface thereof. This oxide films are derived from the metal magnetic particles and are formed by heat treatment. In the element body 10, adjacent metal magnetic particles may be joined to each other via oxide films.

The element body 10 may be impregnated with a resin material after being burned to further improve the strength of the element body. For example, an epoxy resin, a phenolic resin, and/or a silicone resin may be used to improve the strength of the element body.

### External Electrodes

The external electrodes are provided on the bottom surface of the element body 10. The external electrodes include the first external electrode E1, the second external electrode E2, the third external electrode E3, and the fourth external electrode E4. The first external electrode El and the second external electrode E2 may be electrically connected to the first coil 21. In addition, the third external electrode E3 and the fourth external electrode E4 may be electrically connected to the second coil 22. When the external electrodes are provided on the bottom surface (first main surface 11) of the element body 10, the multilayer inductor 1A can be appropriately mounted on a mounting board or the like.

The first external electrode E1 may function as an input electrode and/or an output electrode for the first coil 21. The first external electrode El may be provided only on the first main surface 11 of the element body 10 but may be provided across the first main surface 11 and at least one of the second end surface 14, the first side surface 15, and the second side surface 16 of the element body 10.

The second external electrode E2 may function as an input electrode and/or an output electrode for the second coil 22. The second external electrode E2 may be provided only on the first main surface 11 of the element body 10 but may be provided across the first main surface 11 and at least one of the first end surface 13 and/or the first side surface 15 of the element body 10.

The third external electrode E3 may function as an input electrode and/or an output electrode for the second coil 22. The third external electrode E3 may be provided only on the first main surface 11 of the element body 10 but may be provided across the first main surface 11 and at least one of the first end surface 13 and/or the second side surface 16 of the element body 10.

The fourth external electrode E4 may function as an input electrode and/or an output electrode for the second coil 22. The fourth external electrode E4 may be provided only on the first main surface 11 of the element body 10 but may be provided across the first main surface 11 and at least one of the second end surface 14 and/or the first side surface 15 of the element body 10.

In a preferable aspect of the external electrodes, the plane areas of the external electrodes viewed from the mounting surface of the element body 10 may be smaller than the plane areas of the first to fourth through-conductors T1 to T4 of the multilayer group G10. When the plane areas of the external electrodes are smaller than the plane areas of the first to fourth through-conductors T1 to T4 of the multilayer group G10, the external electrodes that require predetermined positional accuracy with respect to the element body can be easily connected to the through-conductors that are displaced due to heat shrinkage caused by burning.

The material of the external electrodes may be various materials, such as Cu and/or Ni. In addition, the external electrode may include one layer or have a multilayer structure including two or more layers. The external electrode may be formed by any method and may be, for example, a plated electrode formed by plating, such as electroless plating.

### First Coil

The first coil 21 is provided in the element body 10. The first coil 21 provided in the element body 10 includes a first winding portion W1 formed by connecting, through the first vias V1, the end portions of the plurality of first conductors C1 disposed in different layers of the element body 10, the first through-conductor T1, and the second through-conductor T2.

The first winding portion W1 may include the first conductors C1 and the first vias V1 provided in the multilayer groups G2 to G8. Specifically, in the first winding portion W1, counterclockwise winging with respect to the second external electrode E2 may be performed.

The first via V1 may electrically connect the first conductors C1 provided in multilayer groups adjacent to each other in the lamination direction. The length of the first via V1 in the lamination direction may be shorter than the length of the first through-conductor T1 or the length of the second through-conductor T2. In addition, the first conductor C1 may have a multilayer structure.

The first through-conductor T1 may connect, to each other, the first external electrode E1 and the end portion of the first conductor C1 closest to the bottom surface (the first main surface 11) of the element body 10 of end portions of the first coil 21. The first through-conductor T1 may extend in the lamination direction (for example, the height direction T). The first through-conductor T1 may have a multilayer structure.

The second through-conductor T2 may connect the other end portion of the first coil 21 and the second external electrode E2 to each other. The second through-conductor T2 may extend in the lamination direction (for example, the height direction T). The second through-conductor T2 may have a multilayer structure.

### Second Coil

The second coil 22 is provided in the element body 10. The second coil 22 provided in the element body 10 includes a second winding portion W2 formed by connecting, through the second vias V2, the end portions of the plurality of second conductors C2 disposed in different layers of the element body 10, the third through-conductor T3, and the fourth through-conductor T4.

The second winding portion W2 may include the second conductors C2 and the second vias V2 provided in the multilayer groups G2 to G8. Specifically, in the second winding portion W2, counterclockwise winding with respect to the fourth external electrode E4 located diagonally from the second external electrode E2 may be performed. In the multilayer inductor 1A according to the present disclosure, in view of reducing the difference in the DC resistance and/or the inductance value between the first coil 21 and the second coil 22, the number of turns of the first winding portion W1 and the number of turns of the second winding portion W2 may be substantially identical to each other.

The second via V2 may electrically connect the second conductors C2 provided in multilayer groups adjacent to each other in the lamination direction. The length of the second via V2 in the lamination direction may be shorter than the length of the third through-conductor T3 or the length of the fourth through-conductor T4. In addition, the second conductor C2 may have a multilayer structure.

The third through-conductor T3 may connect, to each other, the third external electrode E3 and the end portion of the second conductor C2 closest to the bottom surface (the first main surface 11) of the element body 10 of end portions of the second coil 22. The third through-conductor T3 may extend in the lamination direction (for example, the height direction T). The third through-conductor T3 may have a multilayer structure.

The fourth through-conductor T4 may connect the other end portion of the second coil 2 and the fourth external electrode E4 to each other. The fourth through-conductor T4 may extend in the lamination direction (for example, the height direction T). The fourth through-conductor T4 may have a multilayer structure.

As described above, according to the present disclosure, in the inductor including a plurality of coils therein, the difference in the DC resistance and/or the inductance value between the coils can be reduced.

### Additional Structure of Multilayer Inductor

In the multilayer inductor 1A described above, the first conductor C1 may be point-symmetric with the second conductor C2 about the center of the magnetic layers ML in plan view in the lamination direction. Specifically, in FIG. 3, in the multilayer groups G2, G4, G6, and G8 each of which has the first conductor C1 and the second conductor C2, when rotated 180° about the center of the magnetic layer ML, the multilayer groups G2, G4, G6, and G8 overlap each other.

In the structure described above, since the area of the first conductor C1 in plan view in the lamination direction in a single layer is substantially identical to the area of the second conductor C2 in plan view in the lamination direction, the difference in the DC resistance and/or the inductance value between the coils can be further reduced.

In the multilayer inductor 1A described above, the first conductor C1 and the second conductor C2 may overlap each other in an overlapping region in plan view in the lamination direction. That is, the arrangement relationship between the first conductor C1 and the second conductor C2 is determined among different multilayer groups. More specifically, the first conductor C1 of the multilayer group G2 is disposed along two sides that form a corner portion (for example, a corner portion close to the third external electrode E3 in planar transparent view) of the magnetic layer ML, and the second conductor C2 of the multilayer group G4 is disposed along some portions of two sides that form a corner portion (for example, a corner portion close to the third external electrode E3 in planar transparent view) of the magnetic layer. Accordingly, between the multilayer group G2 and the multilayer group G4, there is an overlapping region R2 in which the first conductor C1 and the second conductor C2 overlap each other in plan view in the lamination direction.

In the structure described above, the positional relationship between the first conductor C1 and the second conductor C2 is determined not only in a single multilayer group but also between different multilayer groups, and an overlapping region between the first conductor C1 and the second conductor C2 is present. As a result, the first conductor C1 and the second conductor C2 are substantially similar to each other. Accordingly, coupling between the first coil 21 and the second coil 22 can be enhanced.

In the multilayer inductor 1A described above, the first conductor C1 may have a first avoidance portion Al that avoids the second through-conductor T2, and/or the second conductor C2 may have a second avoidance portion A2 that avoids the fourth through-conductor T4. In the structure described above, since the second through-conductor T2 and the fourth through-conductor T4 can be disposed in positions avoided by the first avoidance portion Al and the second avoidance portion A2 in the plan view in the lamination direction, the multilayer inductor can be smaller in plan view in the lamination direction than a multilayer inductor having no avoidance portions.

In a more preferable aspect of the avoidance portion, the first avoidance portion A1 may be located inward of the second through-conductor T2 in plan view in the lamination direction on the magnetic layer ML, and/or the second avoidance portion A2 may be located inward of the fourth through-conductor T4 in plan view in the lamination direction on the magnetic layer ML. The multilayer inductor having the structure described above can be much smaller in plan view in the lamination direction than a multilayer inductor having no avoidance portions.

In the multilayer inductor 1A described above, the first external electrode E1, the second external electrode E2, the third external electrode E3, and the fourth external electrode E4 may be provided in corner portions of the element body 10 that is rectangular in plan view in the lamination direction. Since these external electrodes can be separated from each other as much as possible when the first to fourth external electrodes E4 are provided in the corner portions of the element body 10 that is rectangular in plan view in the lamination direction, the dielectric strength voltages between the external electrodes can be increased.

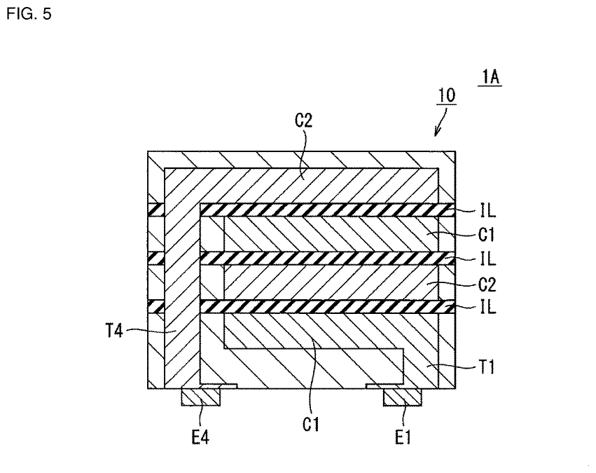

In the multilayer inductor 1A described above, an insulating layer IL may be disposed between the first conductor C1 and the second conductor C2 in the lamination direction (see FIG. 5). For example, the magnetic layers ML of the multilayer groups G3, G5 and G7 illustrated in FIG. 3 may be replaced with the insulating layers IL. The insulating layer IL provided between the first conductor C1 and the second conductor C2 in the lamination direction can increase the dielectric strength voltage between the first conductor C1 and the second conductor C2.

### Multilayer Inductor Array

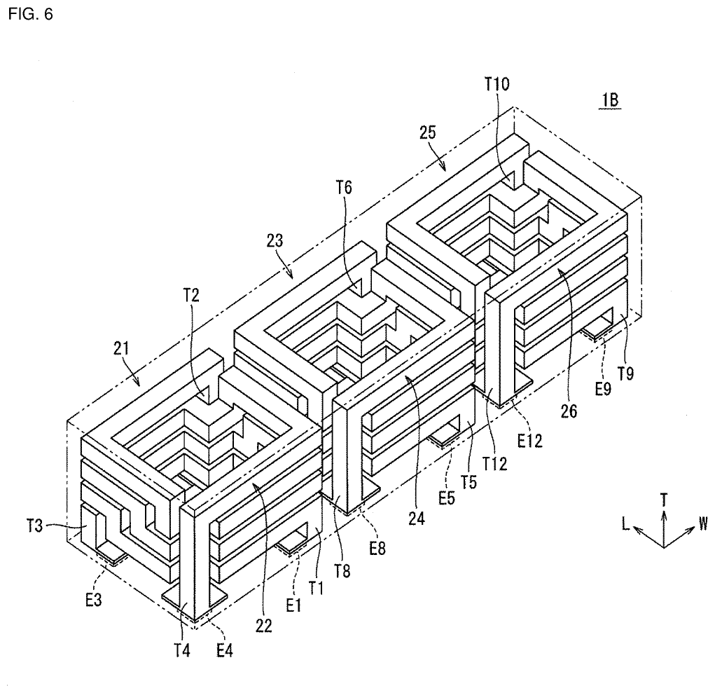

Next, a multilayer inductor array according to the present disclosure will be described with reference to FIG. 6. In a multilayer inductor array 1B according to the present disclosure, the first coil and the second coil constitute a coil array by being provided in parallel in a direction intersecting the lamination direction. Specifically, the coil array may include a third coil 23, a fourth coil 24, a fifth coil 25, and a sixth coil 26 in addition to the first coil 21 and the second coil 22. It should be noted that the third coil 23 and the fifth coil 25 have substantially the same structure as the first coil 21, and the fourth coil 24 and the sixth coil 26 have substantially the same structure as the second coil 22.

The third coil 23 may be electrically connected to a fifth external electrode E5 and a sixth external electrode (not illustrated). A fifth through-conductor T5 may connect, to each other, the fifth external electrode E5 and the end portion of the third conductor closest to the bottom surface of end portions of the third coil 23. In addition, a sixth a through-conductor T6 may connect the other end portion of the third conductor and the sixth external electrode (not illustrated) to each other.

The fourth coil 24 may be electrically connected to a seventh external electrode (not illustrated) and an eighth external electrode E8. The seventh through-conductor (not illustrated) may connect, to each other, the seventh external electrode (not illustrated) and the end portion of the fourth conductor closest to the bottom surface of end portions of the fourth coil 24. In addition, an eighth through-conductor T8 may connect the other end portion of the fourth conductor and the eighth external electrode E8 to each other.

The fifth coil 25 may be electrically connected to a ninth external electrode E9 and a tenth external electrode (not illustrated). A ninth through-conductor T9 may connect, to each other, the ninth external electrode E9 and the end portion of the fifth conductor closest to the bottom surface of end portions of the fifth coil 25. In addition, a tenth through-conductor T10 may connect the other end portion of the fifth conductor and the tenth external electrode (not illustrated) to each other.

The sixth coil 26 may be electrically connected to an eleventh external electrode (not illustrated) and a twelfth external electrode E12. The eleventh through-conductor (not illustrated) may connect, to each other, the eleventh external electrode (not illustrated) and the end portion of the sixth conductor closest to the bottom surface of end portions of the sixth coil 26. In addition, a twelfth through-conductor T12 may connect the other end portion of the sixth conductor and the twelfth external electrode E12 to each other.

Also in the multilayer inductor array 1B according to the present disclosure, the first conductor and the second conductor are provided in a single layer, the area of the first conductor in plan view in the lamination direction in the single layer is substantially identical to the area of the second conductor in plan view in the lamination direction, the first conductors and the second conductors are alternately disposed in the direction intersecting the lamination direction, the third conductor and the fourth conductor are provided in a single layer, the area of the third conductor in plan view in the lamination direction in the single layer is substantially identical to the area of the fourth conductor in plan view in the lamination direction, and the third conductors and the fourth conductors are alternately disposed in the direction intersecting the lamination direction. Accordingly, the difference in the DC resistance and/or the inductance value between the coils can be reduced.

In addition, the technical scope of the present disclosure is not interpreted solely by the aspects described above and is defined in accordance with the description of the claims. In addition, the technical scope of the present disclosure includes all changes within the meaning and range equivalent to the scope of the claims.

The multilayer inductor and the multilayer inductor array according to the present disclosure include the following aspects.

<1> A multilayer inductor comprising an element body including a plurality of magnetic layers laminated in a lamination direction; and a first external electrode, a second external electrode, a third external electrode, and a fourth external electrode that are provided on a bottom surface of the element body. The multilayer inductor also includes a first coil including a first winding portion formed by connecting, through a via, end portions of a plurality of first conductors disposed in different layers of the element body, a first through-conductor that connects one end of the first winding portion that is relatively close to the bottom surface and the first external electrode to each other, and a second through-conductor that connects another end of the first winding portion that is relatively away from the bottom surface and the second external electrode to each other. The multilayer inductor further includes a second coil including a second winding portion formed by connecting, through a via, end portions of a plurality of second conductors disposed in different layers of the element body, a third through-conductor that connects one end of the second winding portion that is relatively close to the bottom surface and the third external electrode to each other, and a fourth through-conductor that connects another end of the second winding portion that is relatively away from the bottom surface and the fourth external electrode to each other. A first conductor and a second conductor are provided in a single layer, the first conductor being one of the plurality of first conductors, the second conductor being one of the plurality of second conductors, and an area of the first conductor in plan view is substantially identical to an area of the second conductor in plan view in the single layer. In addition, the first conductors and the second conductors are alternately disposed as viewed in a direction intersecting the lamination direction.

<2> The multilayer inductor according to <1>, wherein the first conductor is point-symmetric with the second conductor in plan view about a center of the magnetic layers.

<3> The multilayer inductor according to <1> or <2>, wherein the first conductor and the second conductor overlap each other in an overlapping region in plan view.

<4> The multilayer inductor according to any one of <1> to <3>, wherein the first conductor has a first avoidance portion that avoids the second through-conductor, and/or the second conductor has a second avoidance portion that avoids the fourth through-conductor.

<5> The multilayer inductor according to <4>, wherein the first avoidance portion is located inward of the second through-conductor in plan view on the magnetic layer, and/or the second avoidance portion is located inward of the fourth through-conductor in plan view on the magnetic layer.

<6> The multilayer inductor according to any one of <1> to <5>, wherein the first external electrode, the second external electrode, the third external electrode, and the fourth external electrode are provided in corner portions of the element body that is rectangular in plan view.

<7> The multilayer inductor according to any one of <1> to <6>, wherein an insulating layer is disposed between the first conductor and the second conductor in the lamination direction.

<8> A multilayer inductor array comprising an element body including a plurality of magnetic layers laminated in a lamination direction; and a first external electrode, a second external electrode, a third external electrode, a fourth external electrode, a fifth external electrode, a sixth external electrode, a seventh external electrode, and an eighth external electrode that are provided on a bottom surface of the element body. The multilayer inductor array also includes a first coil including a first winding portion formed by connecting, through a via, end portions of a plurality of first conductors disposed in different layers of the element body, a first through-conductor that connects one end of the first winding portion that is relatively close to the bottom surface and the first external electrode to each other, and a second through-conductor that connects another end of the first winding portion that is relatively away from the bottom surface and the second external electrode to each other. The multilayer inductor array further includes a second coil including a second winding portion formed by connecting, through a via, end portions of a plurality of second conductors disposed in different layers of the element body, a third through-conductor that connects one end of the second winding portion that is relatively close to the bottom surface and the third external electrode to each other, and a fourth through-conductor that connects another end of the second winding portion that is relatively away from the bottom surface and the fourth external electrode to each other. The multilayer inductor array also includes a third coil including a third winding portion formed by connecting, through a via, end portions of a plurality of third conductors disposed in different layers of the element body, a fifth through-conductor that connects one end of the third winding portion that is relatively close to the bottom surface and the fifth external electrode to each other, and a sixth through-conductor that connects another end of the third winding portion that is relatively away from the bottom surface and the sixth external electrode to each other. The multilayer inductor array further includes a fourth coil including a fourth winding portion formed by connecting, through a via, end portions of a plurality of fourth conductors disposed in different layers of the element body, a seventh through-conductor that connects one end of the fourth winding portion that is relatively close to the bottom surface and the seventh external electrode to each other, and an eighth through-conductor that connects another end of the fourth winding portion that is relatively away from the bottom surface and the eight external electrode to each other. Also, the third coil and the fourth coil are adjacent to each other in a direction intersecting the lamination direction with respect to the first coil and the second coil. In addition, a first conductor and a second conductor are provided in a single layer, the first conductor being one of the plurality of first conductors, the second conductor being one of the plurality of second conductors, and an area of the first conductor in plan view is substantially identical to an area of the second conductor in plan view in the single layer. Furthermore, the first conductors and the second conductors are alternately disposed in the direction intersecting the lamination direction, the third conductor and the fourth conductor are provided in a single layer, and an area of the third conductor in plan view is substantially identical to an area of the fourth conductor in plan view in the single layer, and the third conductors and the fourth conductors are alternately disposed in the direction intersecting the lamination direction.

The present disclosure is applicable to multilayer inductors and multilayer inductor arrays that can reduce the difference in the DC resistance and/or the inductance value between a plurality of coils included in each of the inductors.

What is claimed is:

1. A multilayer inductor comprising:
an element body including a plurality of magnetic layers laminated in a lamination direction;
a first external electrode, a second external electrode, a third external electrode, and a fourth external electrode that are on a bottom surface of the element body;
a first coil including a first winding portion configured by connecting, through a via, end portions of a plurality of first conductors in different layers of the element body, a first through-conductor that connects one end of the first winding portion that is relatively close to the bottom surface and the first external electrode to each other, and a second through-conductor that connects another end of the first winding portion that is relatively away from the bottom surface and the second external electrode to each other; and
a second coil including a second winding portion configured by connecting, through a via, end portions of a plurality of second conductors in different layers of the element body, a third through-conductor that connects one end of the second winding portion that is relatively close to the bottom surface and the third external electrode to each other, and a fourth through-conductor that connects another end of the second winding portion that is relatively away from the bottom surface and the fourth external electrode to each other,
wherein a first conductor and a second conductor are in a same layer, the first conductor being one of the plurality of first conductors, the second conductor being one of the plurality of second conductors, and an area of the first conductor in plan view is substantially same to an area of the second conductor in plan view in the same layer, and
the first conductors and the second conductors are alternately disposed as viewed in a direction intersecting the lamination direction.

2. The multilayer inductor according to claim 1, wherein
the first conductor is point-symmetric with the second conductor in plan view about a center of the magnetic layers.

3. The multilayer inductor according to claim 1, wherein
the first conductor and the second conductor overlap each other in an overlapping region in plan view.

4. The multilayer inductor according to claim 1, wherein
at least one of
the first conductor has a first avoidance portion that avoids the second through-conductor, or
the second conductor has a second avoidance portion that avoids the fourth through-conductor.

5. The multilayer inductor according to claim 4, wherein
at least one of
the first avoidance portion is inward of the second through-conductor in plan view on at least one of the magnetic layers, or
the second avoidance portion is inward of the fourth through-conductor in plan view on at least one of the magnetic layers.

6. The multilayer inductor according to claim 1, wherein
the first external electrode, the second external electrode, the third external electrode, and the fourth external electrode are in corner portions of the element body that is rectangular in plan view.

7. The multilayer inductor according to claim 1, wherein
an insulating layer is between the first conductor and the second conductor in the lamination direction.

8. A multilayer inductor array comprising:
an element body including a plurality of magnetic layers laminated in a lamination direction;
a first external electrode, a second external electrode, a third external electrode, a fourth external electrode, a fifth external electrode, a sixth external electrode, a seventh external electrode, and an eighth external electrode that are on a bottom surface of the element body;
a first coil including a first winding portion configured by connecting, through a via, end portions of a plurality of first conductors in different layers of the element body, a first through-conductor that connects one end of the first winding portion that is relatively close to the bottom surface and the first external electrode to each other, and a second through-conductor that connects another end of the first winding portion that is relatively away from the bottom surface and the second external electrode to each other;
a second coil including a second winding portion configured by connecting, through a via, end portions of a plurality of second conductors in different layers of the element body, a third through-conductor that connects one end of the second winding portion that is relatively close to the bottom surface and the third external electrode to each other, and a fourth through-conductor that connects another end of the second winding portion that is relatively away from the bottom surface and the fourth external electrode to each other;
a third coil including a third winding portion configured by connecting, through a via, end portions of a plurality of third conductors in different layers of the element body, a fifth through-conductor that connects one end of the third winding portion that is relatively close to the bottom surface and the fifth external electrode to each other, and a sixth through-conductor that connects another end of the third winding portion that is relatively away from the bottom surface and the sixth external electrode to each other,
a fourth coil including a fourth winding portion configured by connecting, through a via, end portions of a plurality of fourth conductors in different layers of the element body, a seventh through-conductor that connects one end of the fourth winding portion that is relatively close to the bottom surface and the seventh external electrode to each other, and an eighth through-conductor that connects another end of the fourth winding portion that is relatively away from the bottom surface and the eight external electrode to each other,
the third coil and the fourth coil are adjacent to each other in a direction intersecting the lamination direction with respect to the first coil and the second coil,
a first conductor and a second conductor are in a same layer, the first conductor being one of the plurality of first conductors, the second conductor being one of the plurality of second conductors, and an area of the first conductor in plan view is substantially same to an area of the second conductor in plan view in the same layer,
the first conductors and the second conductors are alternately disposed in the direction intersecting the lamination direction,
a third conductor and a fourth conductor are in a same layer, the third conductor being one of the plurality of the third conductors, the fourth conductor being one of the plurality of the fourth conductors, and an area of the third conductor in plan view is substantially same to an area of the fourth conductor in plan view in the same layer, and
the third conductors and the fourth conductors are alternately disposed in the direction intersecting the lamination direction.
